(19) United States
(12) Patent Application Publication
(10) Pub. No.: US 2019/0065406 A1
(43) Pub. Date: Feb. 28, 2019

(54) Technology For Establishing Trust During A Transport Layer Security Handshake

(71) Applicant: Intel Corporation, Santa Clara, CA (US)

(72) Inventors: Michael Steiner, Portland, OR (US); Thomas Knauth, Hillsboro, OR (US); Li Lei, Hillsboro, OR (US); Bin Xing, Hillsboro, OR (US); Mona Vij, Hillsboro, OR (US); Somnath Chakrabarti, Portland, OR (US)

(21) Appl. No.: 16/174,337

(22) Filed: Oct. 30, 2018

Related U.S. Application Data
(60) Provisional application No. 62/587,654, filed on Nov. 17, 2017.

(51) Int. Cl. G06F 12/14; H04L 29/06

(52) U.S. Cl. CPC G06F 12/1408; H04L 63/0428; H04L 2463/062; G06F 2212/1052; H04L 63/166

(57) ABSTRACT

In a method for protecting extra-enclave communications, a data processing system allocates a portion of random access memory (RAM) to a server application that is to execute at a low privilege level, and the data processing system creates an enclave comprising the portion of RAM allocated to the server application. The enclave protects the RAM in the enclave from access by software that executes at a high privilege level. The server application obtains a platform attestation report (PAR) for the enclave from the processor. The PAR includes attestation data from the processor attesting to integrity of the enclave. The server application also generates a public key certificate for the server application. The public key certificate comprises the attestation data. The server application utilizes the public key certificate to establish a transport layer security (TLS) communication channel with a client application outside of the enclave. Other embodiments are described and claimed.

This application claims priority to U.S. Provisional Patent Application No. 62/587,654, filed on Nov. 17, 2017, entitled “Methods And Apparatus To Protect Extra-Enclave Communications,” with inventors Michael Steiner, Thomas Knauth, Li Lei, Bin Xing, Mona Vij, and Somnath Chakrabarti, the disclosure of which is hereby incorporated herein by reference.

### TECHNICAL FIELD

The present disclosure pertains in general to data processing systems and in particular to computer security.

### BACKGROUND

Intel Corporation has created an Intel® architecture extension designed to increase the security of application code and data. This technology is referred to under the name or trademark of “Intel® Software Guard Extensions” or “Intel® SGX.” This technology helps application developers to protect select code and data from disclosure or modification. Intel® SGX makes such protection possible through the use of enclaves. As described in greater detail below, one aspect of an enclave is that it provides a protected area of execution in memory. In particular, a data processing system may use an enclave to prevent hardware and software that reside outside of an enclave from accessing or modifying code and data inside that enclave. Thus, an enclave may protect the code and data in that enclave from disclosure or modification. Therefore, a data processing system may use an enclave to protect the state of the code in that enclave. In particular, as indicated by the Wikipedia® entry for “Software Guard Extensions,” Intel® SGX involves a set of central processing unit (CPU) code instructions “that allows user-level code to allocate private regions of memory, called enclaves, that are protected from processes running at higher privilege levels.” Application developers can cause a data processing system to put application code into an enclave by using special instructions in the processor architecture and by using software that has been made available to developers via the Intel® SGX software development kit (SDK). In addition, Intel® SGX includes features which enable an enclave to provide cryptographic proof of its identity to a remote entity. Intel® SGX features also support remote attestation.

Also, some data processing systems may use similar technology from other manufacturers to manage enclaves and to support remote attestation.

For purposes of this disclosure, an “enclave” is a portion of the random access memory (RAM) of a data processing system (e.g., a set of pages) that is protected by the data processing system from software that runs in the data processing system at a higher privilege level than the software in the enclave. For instance, the OS in a data processing system may be unable to access the portion of RAM that has been allocated to an application in that data processing system, once that portion of RAM has been configured as an enclave. An enclave may also be referred to as a “trusted execution environment.” Also, for purposes of this disclosure, software that executes within an enclave may be referred to as “enclave-protected software” (EPS), and software that executes outside of that enclave may be referred to as “external software.”

In many cases, it may be desirable or necessary for EPS to communicate securely with external software. However, conventional technology leaves developers of EPS with the non-trivial task of securing extra-enclave communications. Accordingly, the developer of EPS may also develop a custom communication protocol to enable the EPS to communicate securely with external software. However, developing and using a custom communication protocol may present various disadvantages. For instance, developing a custom communication protocol may substantially increase the amount of work required of the developer of the EPS. Also, the custom communication protocol may require customization of the external software. In addition, a custom communication protocol may not be as secure or reliable as a well-established, standardized communication protocol.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram of an example embodiment of a data processing environment which includes a data processing system with technology for establishing trust between EPS and external software in connection with a handshake process to establish a secure channel between the EPS and the external software.

FIG. 2 is a block diagram illustrating various keys and other data used in the data processing environment of FIG. 1 to establish trust between the EPS and the external software.

FIG. 3 is a block diagram illustrating some of the keys and other data of FIG. 2 in greater detail.

FIGS. 4A and 4B present a flowchart of an example embodiment of a process to facilitate extra-enclave communication protection.

FIG. 5 presents a flowchart of an example embodiment of a process for obtaining a signed attestation verification report for EPS.

FIG. 6 is a flow diagram illustrating certain operations of the EPS and the external software of FIG. 1 and certain communications between those endpoints, in the context of a handshake process to establish a secure channel between those endpoints.

### DETAILED DESCRIPTION

A conventional data processing system typically includes a processor in communication with RAM. The data processing system may load the software into the RAM for execution. That software may include an operating system (OS) that runs at a high level of privilege and one or more applications that run at a lower level of privilege. For instance, the OS may run in ring 0, and the applications may run in ring 3. In an older data processing system, the software in ring 0 may be able to access all of the RAM, but an application in ring 3 may only be able to access the portion of RAM that has been allocated to that application.

As indicated above, a newer data processing system may include technology that can be used to prevent software (e.g., an OS) which runs at a high level of privilege from accessing memory that has been allocated to an application which runs at a lower level of privilege. In particular, a newer data processing system may include technology that enables an application to run in an enclave. In one embodiment, a data processing system may use technology like Intel® SGX to manage enclaves and to support remote attestation. More information on enclaves and on Intel® SGX is available on the Internet at locations such as the following sites (identified as suffixes to be appended to the end of the root address of “software.intel.com”): /en-us/sgx and/en-us/sgx/resource-library. More information is also available at locations such as the following sites (identified as suffixes to be appended to the end of the root address of “software.intel.com/en-us/blogs”): /2013/09/26/protecting-application-secrets-with-intel-sgx and/2016/05/04/introduction-to-intel-sgx-sealing. In other embodiments, data processing systems may use similar technology from other manufacturers to manage enclaves and to support remote attestation.

As indicated above, for purposes of this disclosure, software that runs in an enclave may be referred to as “enclave-protected software” or “EPS,” and software that runs outside of that enclave may be referred to as “external software.” The EPS may be an application, for instance. And the external software may be different application in a different enclave, for instance. Also, communications from an endpoint in an enclave to an endpoint outside of that enclave (i.e., communications between EPS and external software) may be referred to as “extra-enclave communications.” When the endpoints for extra-enclave communications reside in different enclaves, the extra-enclave communications may be referred to as an “inter-enclave communications.”

As indicated above, it may be desirable or necessary for EPS to communicate securely with external software. In other words, it may be desirable or necessary to protect extra-enclave communications. For purposes of this disclosure, technology for protecting extra-enclave communications may be referred to as technology for “extra-enclave communication protection” (EECP).

As indicated above, a conventional enclave does not automatically protect the extra-enclave communications of the EPS. In other words, in a conventional system, if the EPS communicates with an endpoint outside of the enclave, the system does not automatically provide EECP. Accordingly, as indicated above, the developer of the EPS may also develop a custom communication protocol to enable the EPS to communicate securely with external software. For instance, one approach to provide for EECP would be for the endpoints to use Intel® SGX attestation as a one aspect of a custom protocol for secure extra-enclave communications. For instance, to establish a shared secret between two endpoints via a modified SIGMA protocol, that approach could use a software interface that is exposed by the Intel® SGX SDK. (More information about SIGMA protocols may be obtained from the Wikipedia® entry for “Proof of knowledge.”) Thus, EPS could establish a shared secret with external software as one aspect of a custom protocol to provide for EECP. But establishing a shared secret solves only part of the secure communication challenge, since the endpoints would also need to implement a secure channel abstraction (for reading and writing), based on the shared secret.

By contrast, in an embodiment according to the present disclosure, endpoints use the conventional Transport Layer Security (TLS) protocol to implement EECP. TLS is a cryptographic communications protocol that provides communications security between two endpoints. Those endpoints may reside in separate data processing systems, and they may communicate over a computer network. Alternatively, those endpoints may reside in the same data processing system. The protocol referred to as “Secure Sockets Layer” (SSL) was a predecessor of TLS. Vetted implementations of TLS include implementations such as those referred to as “OpenSSL,” “mbed TLS,” “wolfSSL,” and others.

In one embodiment, the endpoints may use the TLS 1.2 protocol and its corresponding standard request for comments (RFC) 5246. (Additional information on RFC 5246 is available on the Internet at www.rfc-base.org/rfc-5246.html.) Nevertheless, EECP as described herein, may be adapted to future versions of TLS or to other protocols using public key certificates to authenticate endpoints. One embodiment may be based on the current remote attestation flow for TLS. However, EECP may be adapted to future iterations of the attestation flow, for instance by changing the specific fields embedded in the public key certificate. Additional information pertaining to attestation may be found in the article entitled “Attestation Transparency: Building secure Internet services for legacy clients” by Jethro Beekman, John Manferdelli, and David Wagner, dated Mar. 15, 2016.

In the field of digital communications, a handshake is an automated sequence of interactions between two endpoints that enables the endpoints to establish a communication session or channel. During that sequence of interactions, the endpoints exchange information that the endpoints then use to establish the communication channel. After successful completion of the handshake, the endpoints may conduct regular communications via that established channel. For instance, during the handshake for a secure communication channel, the endpoints may exchange information pertaining to the keys that will be used to encrypt and decrypt the messages that will subsequently be sent via that secure channel.

As indicated above, the present disclosure describes technology for securing extra-enclave communications. In particular, the present disclosure describes technology for establishing trust between EPS and external software, in connection with a handshake process to establish a TLS channel between the EPS and the external software. For purposes of this disclosure, technology for establishing trust between EPS and external software, in connection with a handshake process to establish a TLS channel between the EPS and the external software, may be referred to as “enclave trust establishment technology” (ETET). In one embodiment, as described in greater detail below, ETET may include a certificate creation module that is used by an attester such as a server application and a certificate verification module that is used by a challenger such as a client application.

For purposes of this disclosure, the term “trust” refers to one or more determinations made by a first endpoint concerning the expected reliability of a second endpoint. The first endpoint may make trust determinations based on one or more attributes of the second endpoint. Those attributes may pertain to the hardware and/or software security features of the second endpoint, the integrity of one or more components of the second endpoint, the identity of the entity that created one or more components of the second endpoint (e.g., whether the developer of a component is the expected developer or an approved developer), etc. For instance, as described in greater detail below, if a client is trying to establish a TLS session with a server, during the handshake process, the client may receive data from the server pertaining to one or more attributes of the server, and the client may determine whether or not the server is trustworthy, based at least in part on that data.

To illustrate EECP and, in particular, ETET, the present disclosure refers to two different endpoints: a challenger and an attester. One aspect of ETET is that the challenger is trying to establish a secure channel (e.g., a TLS channel) to an attester that runs in an enclave. Another aspect of ETET is that the attester is trying to show the challenger that the attester is indeed in a genuine, trustworthy enclave. In addition, the attester wants to tie the secure channel to the attester's enclave. To enable those ends to achieved (e.g., to show the challenger that the attester is trustworthy), as described in greater detail below, the attester obtains a platform attestation report (PAR) and a corresponding quote regarding the identity of the attester and the integrity of attester's enclave. The attester may automatically perform the operations needed to obtain the PAR and the corresponding quote at startup, for instance.

Moreover, Intel® SGX enables the attester to include arbitrary user data in the PAR and in the quote, and the attester uses those abilities to tie a TLS key pair of the attester to this particular enclave instance. For purposes of this disclosure, the term “TLS key pair” refers to the public/private key pair which includes the public key for the attester to send to the challenger during the TLS handshake process as part of the server-hello message. However, the attester need not directly include the public key (of the TLS key pair) in the PAR. Instead, the attester may include a cryptographic hash of the public key. Nevertheless, by including the hash of that public key, the attester enables the challenger to determine that the PAR does indeed pertain to the enclave of the attester. In other words, the cryptographic hash of the public key binds the PAR to the enclave of the attester.

In addition, the attester may send the quote to a remote attestation service operated by a third party (e.g., “Intel® Attestation Service” (IAS) or a remote attestation service provided by any other suitable provider), and that attestation service may reply with a signed attestation verification report. (For purposes of this disclosure, data processing system 120 (or the entity that controls data processing system 120) may be referred to as the “first party, the developer of server application 146 may be referred to as the “second party,” and any other entity may be referred to as a “third party”.) The attester may send that signed attestation verification report to the challenger, and the challenger may use the signed attestation verification report to determine whether or not the attester is trustworthy.

In particular, in one embodiment, the attester generates a unique, ephemeral public/private key pair as the TLS key pair, and the private key never leaves the enclave of the attester. The attester also generates a public key certificate with one or more extensions that include fields which tie the certificate to this enclave and which enable the challenger to verify that the attester is indeed in a genuine, trustworthy enclave. For purposes of this disclosure, a public key certificate with fields that enable the challenger to verify that the attester is in a genuine, trustworthy enclave may be referred to as an “enclave trust establishment (ETE) certificate.” Similarly, those fields may be referred to collectively as an “ETE extension.” In one embodiment, the fields in the ETE extension are specific to Intel® SGX. In other embodiments, those fields may be designed to contain data from other technologies for managing enclaves. In one embodiment, to exchange identity-related information, the endpoints use an ETE certificate that is formatted as an X.509 certificate. More information on X.509 certificates is provided in the Wikipedia® entry for “X.509” at en.wikipedia.org/wiki/X.509. In one embodiment, an ETE certificate is formatted like an X.509 certificate, and it includes at least one ETE extension.

Depending on identity requirements, an ETE certificate can be self-signed (i.e., signed by the attester in the enclave) or signed by a trusted third party. The attester sends the ETE certificate to the challenger during the TLS handshake process. The challenger then performs specific checks on the enclave of the attester, based on the certificate's ETE extension. Those checks may be performed in addition to or in place of some or all of the standard certificate-verification operations. If the challenger is able to verify the data in the ETE extension, the TLS handshake continues and may complete as normal. During or after the handshake, the challenger may also extract other fields of interest from the certificate (e.g., fields providing a measurement or identity of the enclave of the attester and/or fields pertaining to an entity that is responsible for the content of the attester) to perform access control and authentication.

The present disclosure describes one or more embodiments or scenarios involving a client application as the challenger and a server application as the attester. In particular, the server application and the client application use ETET to facilitate EECP.

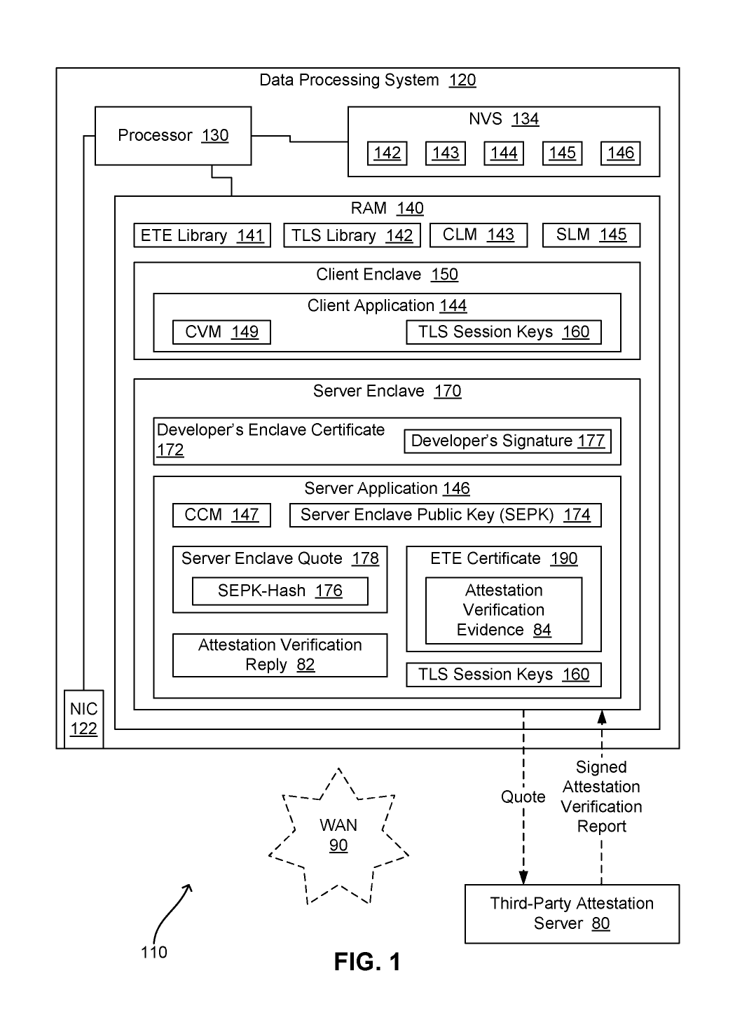

FIG. 1 is a block diagram of an example embodiment of a data processing environment 110 which includes a data processing system 120 with technology for establishing trust between EPS and external software in connection with a handshake process to establish a TLS channel between the EPS and the external software. In other words, data processing system 120 include ETET.

As illustrated, data processing system 120 includes a processor 130 in communication with RAM 140, nonvolatile storage (NVS) 134, and a network interface controller (NIC) 122. Data processing system 120 may also include various other hardware components in communication (directly or indirectly) with processor 130. Data processing system 120 may copy software from NVS 134 into RAM 140 for execution.

In the embodiment of FIG. 1, the EPS is implemented as a server application 146 which executes in server enclave 170, and the external software is implemented as a client application 144 which executes in client enclave 150. NVS 134 may also include a server launch module (SLM) 145 and a client launch module (CLM) 143. When data processing system 120 executes SLM 145, SLM may cause data processing system 120 to (a) copy server application 146 into a portion of memory, (b) designate that portion of memory as an enclave (e.g., server enclave 170), (c) initialize server enclave 170, and then (d) launch server application 146 to execute within server enclave 170. Similarly, when data processing system 120 executes CLM 143, CLM 143 may cause data processing system 120 to (a) copy client application 144 into a different portion of memory, (b) designate that portion of memory as another enclave (e.g., client enclave 150), (c) initialize client enclave 150, and then (d) launch client application 144 to execute within client enclave 150. Thus, the embodiment of FIG. 1 involves two endpoints (server application 146 and client application 144) which execute or reside in respective enclaves. The enclaves themselves may also be considered endpoints. However, in other embodiments or scenarios, software such as the client application may run outside of any enclaves. Software such as the client application may even run in a different data processing system from the server application, and the client application may execute with or without enclave protection.

In one embodiment, NVS 134 also includes an ETE library 141 and a TLS library 142, and those libraries include modules for performing cryptographic operations such as certificate parsing, hash sum processing, signature processing, etc. Server application 146 and/or client application 144 may use code from ETE library 141 and TLS library 142 to perform some or all of the operations described below with regard to providing for EECP. For instance, TLS library 142 may include code for performing conventional TLS operations, and ETE library 141 may include code for establishing enclave trust in connection with a TLS handshake process.

In particular, ETE library 141 may include a certificate creation module (CCM) 147 that server application 146 uses to create an ETE certificate 190, as described in greater detail below. ETE library 141 may also include a certificate validation module (CVM) 149 that client application 144 uses to validate ETE certificate 190 (e.g., to perform extended certificate verification), as described in greater detail below.

In one embodiment, CCM 147 is statically linked into server application 146, and CVM 149 is statically linked into client application 144. Accordingly, in FIG. 1, CCM 147 is depicted within server application 146, and CVM 149 is depicted within client application 144. However, other mechanisms to implement the functions of CCM 147 and CVM 140 may be used in other embodiments. For instance, the TLS library and/or the ETE library may be dynamically linked into the client application and/or the server application. In addition or alternatively, some or all of the code to implement the functions of CCM 147 and CVM 140 may be hardcoded into the server application and/or the client application. In addition or alternatively, a library may allow applications to register custom functions through the library's application programming interface (API) (e.g., as callbacks). For instance, in one embodiment, a client application may register a CVM with the TLS library as a callback without changing the TLS library itself. Consequently, in one embodiment, ETET as described herein may work seamlessly with existing TLS libraries.

As described in greater detail below, ETET may be implemented, at least in part, by extending an X.509 certificate with certain fields pertaining to a server enclave (e.g., fields for authentication information provided by Intel® SGX or similar technologies and fields for third-party verification) and by utilizing existing library extension points to include code for certificate creation and certificate verification, in such a way as to enable a challenger to place confidence in the information in the certificate extension.

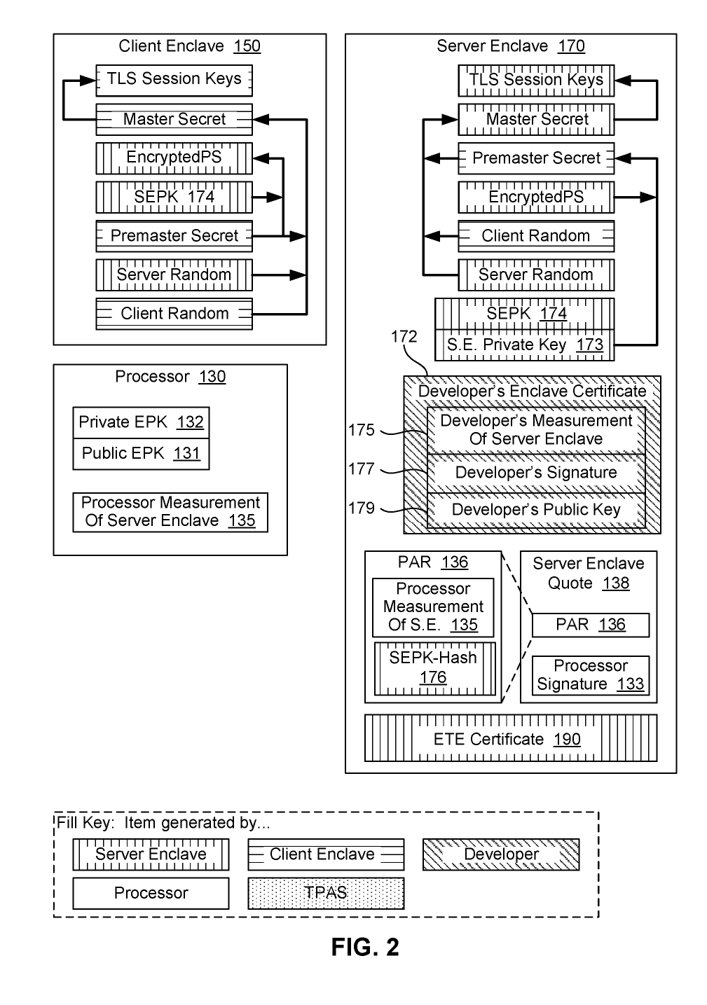

Server enclave 170 may also include additional items to facilitate ETET. For instance, as illustrated in FIG. 1, those items may include a developer's signature 177 and a server enclave public key (SEPK) 174. As described in greater detail below with regard to FIG. 2, server enclave 170 may include developer's signature 177 as part of a developer's enclave certificate 172, for example.

In the embodiment of FIG. 1, data processing environment 110 also includes a third-party attestation server (TPAS) 80. Data processing system 120 may communicate with TPAS 80 via NIC 122 and a wide area network (WAN) 90, for instance.

FIG. 2 is a block diagram illustrating various keys and other data used in data processing environment 110 to establish trust between server application 146 and client application 144.

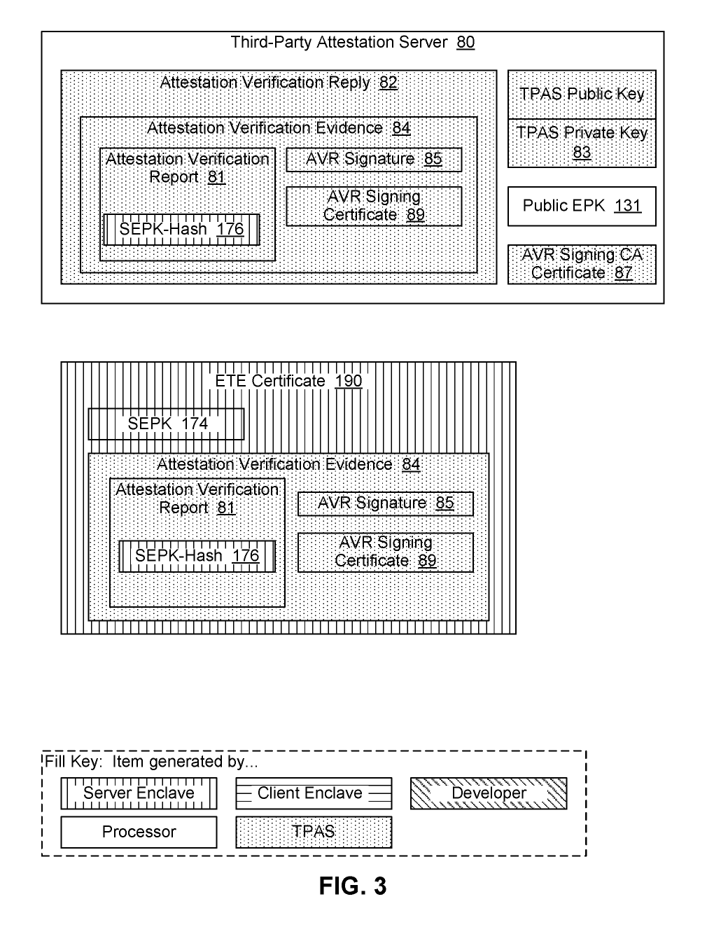

FIG. 3 is a block diagram illustrating some of the keys and other data of FIG. 2 in greater detail.

In particular, FIG. 2 shows various items residing within client enclave 150, server enclave 170, or processor 130, and FIG. 3 shows various items residing in TPAS 80. FIG. 3 also provides more details for ETE certificate 190. Each of FIGS. 2 and 3 also include a “Fill Key” in dashed lines near the bottom. As indicated by that key (which includes the heading “Item generated by”), the blocks for the different items in FIGS. 2 and 3 contain different types of fill, to indicate which component generated each of those items. In particular, blocks or items with vertical lines for fill are generated by server enclave 170, items with horizontal lines for fill are generated by client enclave 150, items with diagonal lines for fill are generated by the developer of server application 146, items with no fill are generated by processor 130 (or by the manufacturer of processor 130), and items with dots for fill are generated by TPAS 80.

In one embodiment, as illustrated in FIG. 2, developer's enclave certificate 172 includes (a) a known-good measurement of server enclave 170 (as initialized with server application 146) from the developer of server application 146, (b) a digital signature over that measurement, generated by the developer using a private key of the developer, and (c) the corresponding public key of the developer. As illustrated, those items may be referred to, respectively, as (a) the developer's measurement 175 of server enclave 170, (b) the developer's signature 177, and (c) the developer's public key 179.

Referring again to FIG. 1, as described in greater detail below, as part of the process for establishing enclave trust, data processing system 120 may use developer's measurement 175, developer's signature 177, and developer's public key 179 to determine whether server enclave 170 is trustworthy. And data processing system 120 may then use SEPK 174 to facilitate EECP between server enclave 170 and client enclave 150. For instance, as part of establishing enclave trust, server application 146 may use processor 130 to generate a quote 138 on server enclave 170, and server enclave quote 138 may include a hash 176 of SEPK 174 (SEPK-Hash). Then, as illustrated by the dashed arrows near the bottom of FIG. 1, (a) server application 146 may use server enclave quote 138 to obtain a signed attestation verification report (AVR) from TPAS 80. In particular, TPAS 80 may send an attestation verification reply 82 to server enclave 170, and as shown in FIG. 3, attestation verification reply 82 may include an AVR 81, as well as other attestation verification evidence 84. Server application 146 may then use attestation verification evidence 84 from attestation verification reply 82 to create an ETE certificate 190. Server application 146 may then use ETE certificate 190 to create a TLS session with client application 144. For instance, server application 146 may send ETE certificate 190 to client application 144, and client application 144 may then use ETE certificate 190 to determine whether server enclave 170 is trustworthy (e.g., to authenticate server enclave 170). And after successful authentication, server application 146 and client application 144 may generate one or more TLS session keys 160 for protecting communications between server enclave 170 and client enclave 150.

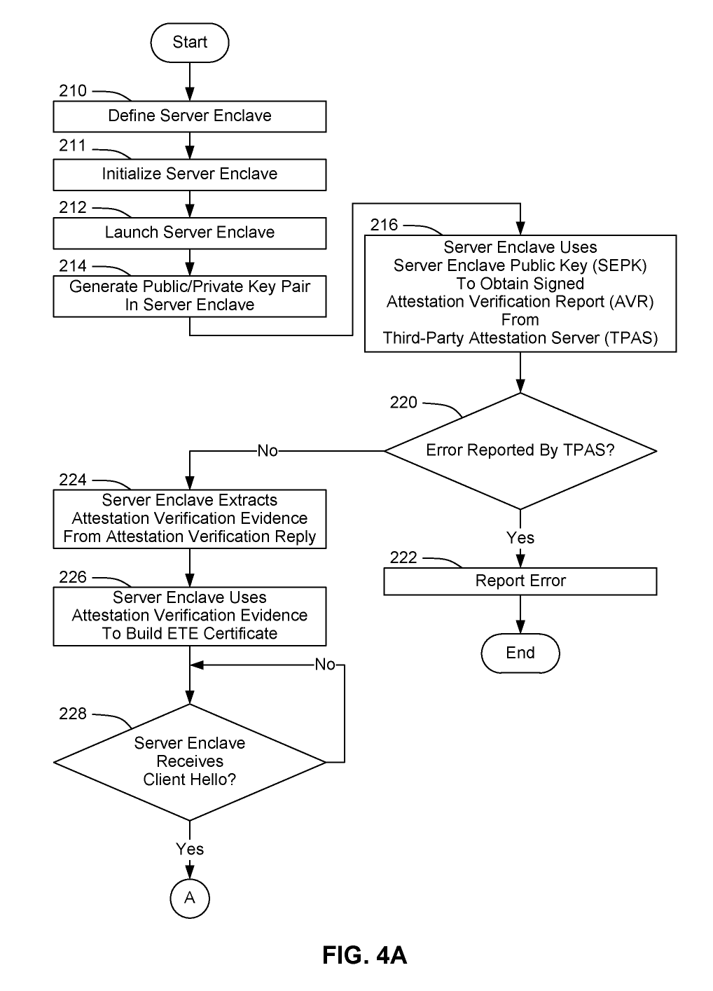

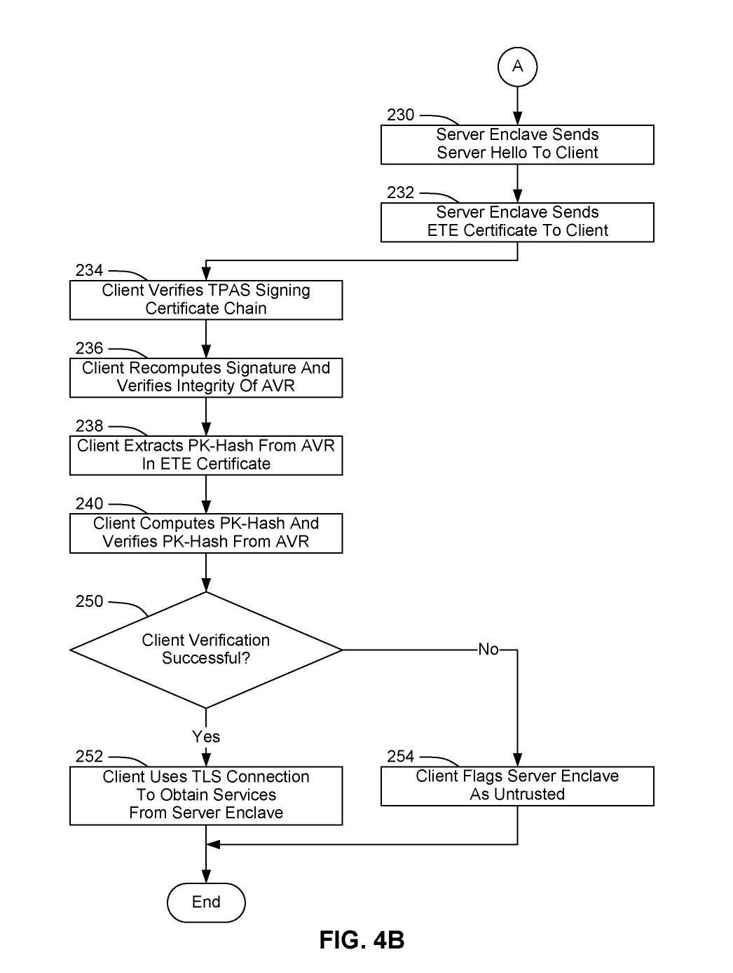

FIGS. 4A and 4B present a flowchart of an example embodiment of a process to facilitate EECP. In particular, FIGS. 4A and 4B illustrate an example embodiment of a process to enable client application 144 to evaluate the trustworthiness of server application 146 and to enable client application 144 and server application 146 to communicate securely. The illustrated process begins at block 210 with SLM 145 defining server enclave 170. For instance, in one embodiment, SLM 145 may load server application 146 and related items (such as developer's enclave certificate 172) into one or more portions of RAM 140; and SLM 145 may then use Intel® SGX instructions such as ECREATE, EADD, and EEXTEND to transform that portion (or those portions) of RAM 140 into an enclave (i.e., into server enclave 170). In other embodiments, different instructions may be used to define server enclaves. As shown at block 211, SLM 145 may then initialize server enclave 170. For instance, SLM 145 may use an Intel® SGX instruction such as EINIT to initialize server enclave 170. In other embodiments, different instructions may be used to initialize server enclaves.

Initialization causes processor 130 to perform a launch preparation process. Part of that launch preparation process is for processor 130 to complete its measurement of server enclave 170. That measurement is depicted in FIG. 2 within processor 130 as “processor measurement of server enclave” 135. Another part of that process is for processor 130 to determine whether server enclave 170 should be considered trustworthy, with regard to (a) processor measurement 135, (b) developer's measurement 175, and developer's signature 177. Thus, processor 130 may compare a known-good measurement of server enclave 170 from the developer of server application 146 with processor measurement 135. For example, as shown in FIG. 2, data processing system 120 may include developer's enclave certificate 172, and as indicated above, that certificate may contain (a) the known-good measurement of server enclave 170 from the developer, (b) the digital signature of the developer over that measurement, and (c) the corresponding public key of the developer. In one embodiment, SLM 145 may use developer's enclave certificate 172 as a so-called “EINITTOKEN” input parameter to the EINIT instruction. Accordingly, initialization may cause processor 130 (a) to verify that processor measurement 135 matches the known-good measurement and (b) to verify that the signature is valid, based on the public key of the developer, thereby verifying that the signature was created using the corresponding private key of the developer. If either of those checks fail, processor 130 may conclude that server enclave 170 is not trustworthy. In addition, the trust determination may also be based the identity of the developer, with regard to a predetermine whitelist of approved developers. If developer's public key 179 is not on that whitelist, processor 130 may conclude that server enclave 170 is not trustworthy. In one embodiment, processor 130 uses a different enclave, known as a “launch enclave,” to perform the launch preparation operations. If processor 130 determines that server enclave 170 is not trustworthy, processor 130 may abort the initialization process with an error message.

Referring again to FIG. 4A, if processor 130 determines that server enclave 170 is trustworthy, data processing system 120 may then launch server application 146 to execute within server enclave 170, as shown at block 212. For instance, in one embodiment, SLM 145 may use an Intel® SGX instruction such EENTER to cause server application 146 to begin execution within server enclave 170. For instance, EENTER may cause processor 130 to switch into enclave mode and to transfer control to server application 146. In other embodiments, different instructions may be used to launch server applications in server enclaves. As shown at block 214, server application 146 then generates a public/private key pair in server enclave 170. As illustrated in FIG. 2, that key pair may include SEPK 174 and a corresponding server enclave private key 173. As shown at block 216 of FIG. 4A, server application 146 in server enclave 170 may then use SEPK 174 to obtain attestation verification reply 82 from TPAS 80. Attestation verification reply 82 may include a signed AVR (SAVR) and other authentication verification evidence.

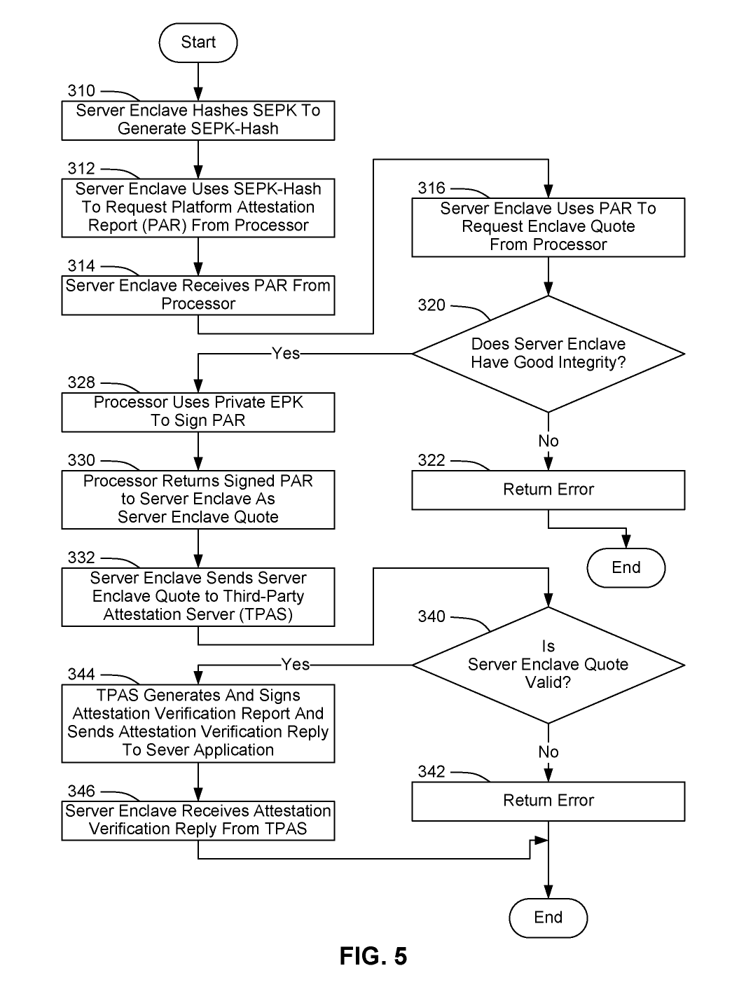

FIG. 5 presents a flowchart of an example embodiment of a process for obtaining an SAVR for enclave-protected software. In particular, FIG. 5 provides additional details to expand upon block 216 of FIG. 4A.

FIG. 5 may begin at block 310 with server application 146 in server enclave 170 hashing SEPK 174 to generate SEPK-Hash 176. As shown at block 312, server application 146 may then use SEPK-Hash 176 to request a platform attestation report (PAR) from processor 130. For instance, in one embodiment, server application 146 may use an Intel® SGX instruction such as EREPORT, while passing SEPK-Hash 176 to EREPORT as a user data parameter. In other embodiments, different instructions may be used to obtain PARs. As shown at block 314, server application 146 may then receive PAR 136 from processor 130. As shown in FIG. 2, PAR 136 may include processor measurement 135 of server enclave 170, as well as a copy of SEPK-Hash 176. In addition, PAR 136 may include a so-called “sealing identity” associated with the authority who provided server application 146 (e.g., the developer), as well as other data items pertaining to aspects of data processing system 120 such as (a) so-called “attributes” identifying modes and other properties established during creation of server enclave 170 and (b) the trustworthiness of the hardware trusted computing base (TCB). PAR 136 may also include a message authentication code (MAC) tag.

As shown at block 316 of FIG. 5, server application 146 may then use PAR 136 to request a quote on server enclave 170 from processor 130. In response, as shown at block 320, processor 130 determines whether server enclave 170 has good integrity and such. In other words, processor 130 uses PAR 136 to authenticate server enclave 170. For instance, processor 130 may recompute the MAC over the signed report data structure and verify that the report was produced by server enclave 170. If server enclave 170 does not have good integrity or otherwise fails authentication, processor 130 may return an error message, as shown at block 322, and the process may then end.

However, if server enclave 170 passes authentication, processor 130 then uses a private key belonging to processor 130 to sign PAR 136, as shown at block 328. In one embodiment, that private key is part of enhanced privacy key (EPK) group. For purposes of this disclosure, an EPK group is a group of keys that includes a public key and two or more private keys, where the public key can be used to verify signatures that have been generated with any of the private keys. For instance, an EPK group may be generated according to technology provided by Intel Corporation under the name or trademark of Intel® Enhanced Privacy ID (EPID). For purposes of this disclosure, the private keys from an EPK group may be referred to as “private EPKs,” and the public key from an EPK group may be referred to as a “public EPK.” For instance, FIG. 2 depicts a public EPK 131 and a private EPK 132. Other processors in other data processing system may include other private EPKs from the same EPK group. Accordingly, the same public EPK 131 may be used to verify signatures created with the private EPK of any of those other data processing systems. In data processing system 120, processor 130 uses private EPK 132 to sign PAR 136. In FIG. 2, that digital signature is illustrated in server enclave quote 138 as processor signature 133. As shown at block 330 of FIG. 5, processor 130 may then return the signed PAR to server enclave 170 as server enclave quote 138.

As shown at block 332, server application 146 may then send server enclave quote 138 to TPAS 80 for third-party verification. As shown at block 340, TPAS 80 then determines whether server enclave quote 138 is valid. For instance, TPAS 80 may use public EPK 131 to determine whether processor signature 133 in server enclave quote 138 is valid, including whether server enclave quote 138 has good integrity, and whether processor signature 133 was created with an approved private EPK, which would indicate that the source of server enclave quote 138 (i.e., data processing system 120) has approved security features, including proper support for enclaves. In other embodiments, TPASs may use other techniques to verify quotes and similar types of messages from enclaves. If server enclave quote 138 is not valid, TPAS 80 may return an error message, as shown at block 342, and the process may then end.

However, if server enclave quote 138 is valid, as shown at block 344, TPAS 80 may generate AVR 81, and TPAS 80 may then use a TPAS private key 83 (as shown in FIG. 3) to sign AVR 81. Such a signature is illustrated in FIG. 3 as AVR signature 85. TPAS 80 may then package AVR 81, AVR signature 85, and various other attestation verification evidence 84 (such as an AVR signing certificate 89) into attestation verification reply 82, and TPAS 80 may send attestation verification reply 82 to server application 146. As shown at block 346, server application 146 may then receive attestation verification reply 82 from TPAS 80. TPAS 80 may also include an AVR signing certification authority (CA) certificate 87 as attestation verification evidence 84 in attestation verification reply 82. Alternatively, client application 144 and/or server application 146 may obtain AVR signing CA certificate 87 from TPAS 80 independently (e.g., via a secure out-of-band connection).

After server application 146 receives attestation verification reply 82 from TPAS 80, the process of FIG. 5 may then end, and processing may resume at block 220 of FIG. 4A. As shown at blocks 220 and 222, if server application 146 received an error from TPAS 80, server application 146 may generate an error report, and the process may then end.

However, if server application 146 did not receive an error from TPAS 80, server application 146 may extract attestation verification evidence 84 from attestation verification reply 82, as shown at block 224. As shown at block 226, server application 146 may then use attestation verification evidence 84 to build ETE certificate 190.

In one embodiment, ETE certificate 190 is a formatted as public key certificate such as an X.509 certificate, and it includes an ETE extension that includes fields to provide for ETE. For instance, the fields in the ETE extension may contain identity information for server enclave 170. For example, in one embodiment, the fields include Intel® SGX-related identity information such as (a) an enclave measurement (MRENCLAVE) and (b) a so-called “Signing Identity” (MRSIGNER) provided by an authority (e.g., the developer of server application 146) which signs the enclave prior to distribution.

In addition or alternatively, those fields includes data that enables the challenger (client application 144) to verify (i) that the attester (server application 146 and/or server enclave 170) is indeed a genuine enclave and (ii) that the public key of the attester in ETE certificate 190 (SEPK 174) is tied to this enclave instance. For instance, those fields may contain data associated with third-party verification of server enclave 170. Accordingly, in the embodiment of FIG. 3, ETE certificate 190 includes fields for data obtained via third-party verification of server enclave 170. As described in greater detail below, the challenger (client application 144) uses the information in ETE certificate 190 to perform authentication and access control. As indicated above, in various embodiments, the challenger may perform some or all of such authentication operations either in place of or in addition to one or more conventional certificate-validation operations.

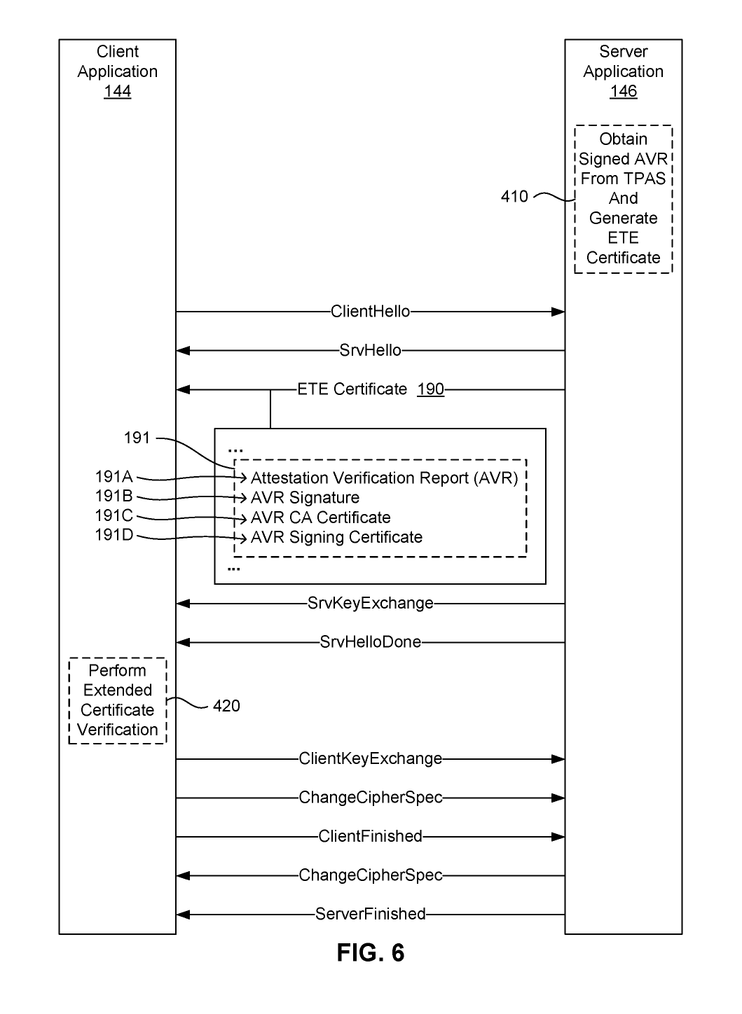

In particular, server application 146 populates various fields in the ETE extension 191 of ETE certificate 190 (as shown in FIG. 6) with the following attestation verification evidence from attestation verification reply 82 (as shown in FIG. 3):
AVR field 191A: gets loaded with attestation verification report 81, from the Hypertext Transfer Protocol (HTTP) body of attestation verification reply 82 (which includes SEPK-Hash 176).
AVR signature field 191B: gets loaded with AVR signature 85, from the x-iasreport-signature HTTP header field of attestation verification reply 82.
AVR signing certificate field 191D: gets loaded with AVR signing certificate 89 from the the x-iasreport-signing-certificate HTTP header field of attestation verification reply 82.
   (More information on attestation verification reports and such may be found in the document entitled “Attestation Service for Intel® Software Guard Extensions (Intel® SGX): API Documentation, Revision: 4.0”.) In addition, server application 146 includes SEPK 174 in ETE certificate 190, as illustrated in FIG. 3.

As shown at block 228 of FIG. 4A, server application 146 then waits to receive a client-hello message from external software such as client application 144. The client-hello message may indicate that client application 144 is trying to establish a TLS channel to server application 146.

FIG. 6 is a flow diagram illustrating certain operations of the EPS and the external software of FIG. 1 and certain communications between those endpoints, in the context of a handshake process to establish a secure channel between those endpoints. In particular, FIG. 6 depicts an enhanced TLS handshake protocol or process for establishing a TLS channel between client application 144 (in client enclave 150) and server application 146 (in server enclave 170), according to one embodiment. As described in greater detail below, the illustrated handshake protocol enables the endpoints to benefit from remote attestation. Once data processing system 120 has launched client application 144 and server application 146, client application 144 and server application 146 may use operations and communications like those illustrated in FIG. 6, and in FIGS. 4A and 4B, to establish a secure channel for extra-enclave communications.

As shown at block 410 of FIG. 6, the handshake protocol may start after server application 146 has obtained a signed AVR from TPAS 80 and generated ETE certificate 190, as described above. Then, as illustrated by the first arrow in FIG. 6, the handshake protocol may start with server application 146 receiving a client-hello message from client application 144. The client-hello message may include a “client random” value. In response to the client-hello message, server application 146 may send a server-hello message to client application 144, as illustrated by the second arrow in FIG. 6 and by block 230 of FIG. 4B. The server-hello message may include a “server random” value. Accordingly, in FIG. 2, “server random” is depicted with fill (vertical lines) to indicate that it was generated by server enclave 170, and “client random” is depicted with fill (horizontal lines) to indicate that it was generated by client enclave 150.

In addition, server application 146 may send ETE certificate 190 to client application 144, as illustrated by the third arrow in FIG. 6 and by block 232 of FIG. 4B. As indicated above, in addition to conventional X.509 certificate content, ETE certificate 190 includes attestation verification evidence 84 (e.g., attestation verification report 81, AVR signature 85, and AVR signing certificate 89). Server application may also send Server-Key-Exchange and Server-Hello-Done messages to the client application, as illustrated by the fourth and fifth arrows in FIG. 6.

As shown at block 420 of FIG. 6, client application 144 may then use CVM 149 to perform extended certificate verification on ETE certificate 190, to verify the validity of ETE certificate 190. In particular, as depicted in blocks 234, 236, 238, and 240 of FIG. 4B, in one embodiment, extended certificate verification includes the following steps:
1. Verify the signing certificate chain of attestation verification report 81. In other words, verify that AVR signing CA certificate 87 and AVR signing certificate 89 constitute a valid signing certificate chain, and that attestation verification report 81 is signed by a trusted attestation service.
2. Verify AVR signature 85 based on the TPAS public key from AVR signing certificate 89.
3. Extract SEPK-Hash 176 (i.e., the cryptographic hash of the public key for server enclave 170) from the user data in attestation verification report 81 in ETE certificate 190, hash SEPK 174 from ETE certificate 190 to generate a fresh hash sum, and verify that SEPK-Hash 176 matches the fresh hash sum.
   In various embodiments, the client application may perform one or more of the above steps (or similar steps) either in place of or in addition to conventional certificate-validation operations.

As shown at blocks 250 and 252 of FIG. 4B, if ETE certificate fails verification by client application 144, client application 144 may flag server enclave 170 as untrusted. In addition or alternatively, client application 144 may generate an error message. The process may then end. However, in response to successful verification, client application 144 may complete the handshake process and then use the resulting TLS connection to receive secure communications from server enclave 170, as shown at block 252.

For instance, as shown in FIG. 6, client application 144 may send a “Client Key Exchange” message to server application 146, and that message may include an encrypted version of a “premaster secret” value. In particular, client application 144 generates the “premaster secret” value as a random number, and then client application 144 uses SEPK 174 to encrypt the “premaster secret” value. In FIG. 2, the encrypted version of the “premaster secret” value is depicted as “EncryptedPS,” and the two arrows that lead into EncryptedPS illustrate that EncryptedPS is based on the “premaster secret value and SEPK 174. In addition, client application 144 uses the “client random,” “server random,” and “premaster secret” values to generate a “master secret” value.

Once server application 146 received EncryptedPS from client application 144, server application 146 uses server enclave private key 173 to decrypt EncryptedPS into the “premaster secret” value. Server application 146 then uses the “client random,” “server random,” and “premaster secret” values to generate a “master secret” value that matches the value generated by client application 144. Client application 144 and server application 146 may then use that “master secret” value to generate one or more TLS session keys, to be used to protect subsequent communications between client application 144 and server application 146. For instance, client application 144 and server application 146 may use a TLS session key after client application 144 and server application 146 send each other “change cipher specification” and “finished” messages, as shown near the bottom of FIG. 6.

Consequently, if server enclave 170 does not have the private key that corresponds to SEPK 174, server enclave 170 will not be able to decrypt EncryptedPS. Therefore, server enclave 170 will not be able to generate the proper “master secret” value, or any TLS session keys based on that “master secret” value.

As has been described, ETET enables developers to leverage protocols like SSL and/or TLS to set up secure channels between applications in enclaves and applications outside of those enclaves. The technology described herein may be used to seamlessly integrate features such as those provided by Intel® SGX remote attestation into a standard TLS channel protocol. Accordingly, ETET may be used with existing TLS libraries and with the existing TLS channel abstraction. However, the X.509-based identity is augmented with attestation attributes like those provided by Intel® SGX or similar technologies. For instance, an attester may use an SSL/TLS certificate as a carrier for attestation and related identity information derived from Intel® SGX technologies or similar technologies. An attester may also bind its TLS key pair to its enclave by embedding a cryptographic hash of the public key as user data into the enclave's report/quote. Integrating ETET according to the present disclosure into an application may be more straightforward, secure, reliable, and flexible than the attempting to integrate other methods of attestation.

Many different types of data processing systems may use ETET to advantage in many different kinds of environments or deployments. For instance, Intel® SGX provides attractive features for the cloud space, and ETET may enhance the capabilities of data processing systems in that environment. In at least one embodiment, ETET enables a data processing system to use Intel® SGX to protect cloud applications by excluding the privileged software from the TCB. Therefore, ETET may be important to fully realize the potential and value of Intel® SGX or similar technologies for cloud security. Moreover, by using ETET, a cloud application can easily support attestation by simply integrating SSL. As a result, Intel® SGX or similar technologies could be adopted more easily and quickly.

The present teachings may be used to provide a secure channel protocol that benefits from Intel® SGX and/or related technologies, and that protocol may be public and standardized. For instance, the present teachings may be used to provide transparent encryption of inter-enclave communication using SSL/TLS, with Intel® SGX and/or related technologies for local and remote attestation for authentication. Thus, ETET may be used to bring authentication information such as that provided by Intel® SGX or similar technologies into the SSL/TLS protocol, thereby enabling applications to easily access that authentication information.

In at least one embodiment, ETET may be implemented as an integrated solution that provides an attested secure channel. For instance, a developer may use ETET instead of (a) using the SIGMA remote attestation protocol to establish a shared secret and then (b) using a custom or proprietary secure channel on top of that shared secret. For instance, a developer may use ETET to provide a secure channel instead of building a secure channel on top of SIGMA using, for example, TLS with the SIGMA key used as a pre-shared key (PSK) for TLS. Alternatively, a developer may use ETET to provide a secure channel instead of running remote attestation inside an unauthenticated TLS channel. ETET thus allows the developer to avoid issues regarding secure channel binding and the breaking of abstraction layers for applications. Moreover, existing applications that do not use Intel® SGX or similar technologies may already use TLS to secure communications. ETET may make it easy to port these applications to Intel® SGX or similar technologies, to provide attested secure channels.

Although certain example embodiments are described herein, one of ordinary skill in the art will understand that those example embodiments may easily be divided, combined, or otherwise altered to implement additional embodiments. In the present disclosure, expressions such as “an embodiment,” “one embodiment,” and “another embodiment” are meant to generally reference embodiment possibilities. Those expressions are not intended to limit the invention to particular embodiment configurations. As used herein, those expressions may reference the same embodiment or different embodiments, and those embodiments are combinable into other embodiments. In light of the principles and example embodiments described and illustrated herein, it will be recognized that the illustrated embodiments can be modified in arrangement and detail without departing from such principles.

Also, as described above, a device may include instructions and other data which, when accessed by a processor, cause the device to perform particular operations. For purposes of this disclosure, instructions which cause a device to perform operations may be referred to in general as software. Software and the like may also be referred to as control logic. Software that is used during a boot process may be referred to as firmware. Software that is stored in nonvolatile memory may also be referred to as firmware. Software may be organized using any suitable structure or combination of structures. Accordingly, terms like program and module may be used in general to cover a broad range of software constructs, including without limitation application programs, subprograms, routines, functions, procedures, drivers, libraries, data structures, processes, microcode, and other types of software components. Also, it should be understood that a software module may include more than one component, and those components may cooperate to complete the operations of the module. Also, the operations which the software causes a device to perform may include creating an operating context, instantiating a particular data structure, etc. Any suitable operating environment and programming language (or combination of operating environments and programming languages) may be used to implement software components described herein.

A medium which contains data and which allows another component to obtain that data may be referred to as a machine-accessible medium or a machine-readable medium. In one embodiment, software for multiple components is stored in one machine-readable medium. In other embodiments, two or more machine-readable media may be used to store the software for one or more components. For instance, instructions for one component may be stored in one medium, and instructions another component may be stored in another medium. Or a portion of the instructions for one component may be stored in one medium, and the rest of the instructions for that component (as well instructions for other components), may be stored in one or more other media. Similarly, software that is described above as residing on a particular device in one embodiment may, in other embodiments, reside on one or more other devices. For instance, in a distributed environment, some software may be stored locally, and some may be stored remotely. Similarly, operations that are described above as being performed on one particular device in one embodiment may, in other embodiments, be performed by one or more other devices.

Accordingly, alternative embodiments include machine-readable media containing instructions for performing the operations described herein. Such media may be referred to in general as apparatus and in particular as program products. Such media may include, without limitation, tangible non-transitory storage components such as magnetic disks, optical disks, dynamic RAM, static RAM, read-only memory (ROM), etc., as well as processors, controllers, and other components that include data storage facilities. For purposes of this disclosure, the term “ROM” may be used in general to refer to nonvolatile memory devices such as erasable programmable ROM (EPROM), electrically erasable programmable ROM (EEPROM), flash ROM, flash memory, etc.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. In some embodiments, some or all of the control logic for implementing the described operations may be implemented in hardware logic (e.g., as microcode in an integrated circuit chip, as a programmable gate array (PGA), as an application-specific integrated circuit (ASIC), etc.).

Additionally, the present teachings may be used to advantage in many different kinds of data processing systems. Such data processing systems may include, without limitation, accelerators, systems on a chip (SOCs), wearable devices, handheld devices, smartphones, telephones, entertainment devices such as audio devices, video devices, audio/video devices (e.g., televisions and set-top boxes), vehicular processing systems, personal digital assistants (PDAs), tablet computers, laptop computers, portable computers, personal computers (PCs), workstations, servers, client-server systems, distributed computing systems, supercomputers, high-performance computing systems, computing clusters, mainframe computers, mini-computers, and other devices for processing or transmitting information. Accordingly, unless explicitly specified otherwise or required by the context, references to any particular type of data processing system (e.g., a PC) should be understood as encompassing other types of data processing systems, as well. A data processing system may also be referred to as an apparatus. The components of a data processing system may also be referred to as apparatus.

Also, unless expressly specified otherwise, components that are described as being coupled to each other, in communication with each other, responsive to each other, or the like need not be in continuous communication with each other and need not be directly coupled to each other. Likewise, when one component is described as receiving data from or sending data to another component, that data may be sent or received through one or more intermediate components, unless expressly specified otherwise. In addition, some components of the data processing system may be implemented as adapter cards with interfaces (e.g., a connector) for communicating with a bus. Alternatively, devices or components may be implemented as embedded controllers, using components such as programmable or non-programmable logic devices or arrays, ASICs, embedded computers, smart cards, and the like. For purposes of this disclosure, the term “bus” includes pathways that may be shared by more than two devices, as well as point-to-point pathways. Similarly, terms such as “line,” “pin,” etc. should be understood as referring to a wire, a set of wires, or any other suitable conductor or set of conductors. For instance, a bus may include one or more serial links, a serial link may include one or more lanes, a lane may be composed of one or more differential signaling pairs, and the changing characteristics of the electricity that those conductors are carrying may be referred to as signals on a line. Also, for purpose of this disclosure, the term “processor” denotes a hardware component that is capable of executing software. For instance, a processor may be implemented as a central processing unit (CPU), a processing core, or as any other suitable type of processing element. A CPU may include one or more processing cores, and a device may include one or more CPUs.

Also, although one or more example processes have been described with regard to particular operations performed in a particular sequence, numerous modifications could be applied to those processes to derive numerous alternative embodiments of the present invention. For example, alternative embodiments may include processes that use fewer than all of the disclosed operations, process that use additional operations, and processes in which the individual operations disclosed herein are combined, subdivided, rearranged, or otherwise altered. Embodiments of technology for establishing trust during a TLS handshake include the following examples:

Example A1 is a data processing system with technology for protecting extra-enclave communications. The data processing system comprises RAM and a processor in communication with the RAM. The processor, when powered on, is capable of (a) allocating a portion of the RAM to a server application that is to execute at a low privilege level, (b) creating an enclave that comprises the portion of the RAM allocated to the server application, and (c) protecting the RAM in the enclave from access by software that executes at a high privilege level. The data processing system further comprises a machine-accessible medium responsive to the processor, and instructions in the machine-accessible medium. When executed by the processor, the instructions enable the server application to (a) obtain a platform attestation report for the enclave from the processor, wherein the platform attestation report includes attestation data from the processor attesting to integrity of the enclave; (b) generate a public key certificate for the server application, wherein the public key certificate comprises the attestation data; and (c) utilize the public key certificate for the server application to establish a TLS communication channel between the server application in the enclave and a client application outside of the enclave.

Example A2 is a data processing system according to Example A1, wherein the instructions, when executed, further enable the server application to (a) after obtaining the platform attestation report for the enclave from the processor, use the platform attestation report to obtain a signed attestation verification report (SAVR) from a third-party attestation server (TPAS); and (b) include the SAVR in the public key certificate. Also, the operation of utilizing the public key certificate for the server application to establish the TLS communication channel comprises utilizing the SAVR from the TPAS to establish the TLS communication channel.

Example A3 is a data processing system according to Example A1, wherein the instructions, when executed, further enable the server application to generate, in the enclave, a private key and a corresponding public key for the server application. Also, the platform attestation report comprises a hash value derived from the public key of the server application, and the public key certificate comprises the hash value. Example A3 may also include the features of Example A2.

Example A4 is a data processing system according to Example A1, wherein the operation of generating the public key certificate for the server application comprises (a) formatting the public key certificate with an X.509 format and (b) including the attestation data in the public key certificate as an X.509 extension. Example A4 may also include the features of any one or more of Examples A2 and A3.

Example A5 is a data processing system according to Example A1, wherein the instructions in the machine-accessible medium, when executed by the processor, implement the server application and a server launch module. Also, the operations of (a) allocating the portion of the RAM to the server application and (b) creating the enclave that comprises the portion of the RAM allocated to the server application are performed by the server launch module. Example A5 may also include the features of any one or more of Examples A2 through A4.

Example A6 is a data processing system according to Example A1, wherein the machine-accessible medium further comprises a developer's enclave certificate for the enclave, wherein the developer's enclave certificate comprises a predetermined developer's measurement of the enclave and a digital signature of the developer, based on the predetermined developer's measurement of the enclave. Also, the processor, when powered on, is capable of using the developer's enclave certificate to evaluate trustworthiness of the server application before allowing the server application to execute in the enclave. Example A6 may also include the features of any one or more of Examples A2 through A5.

Example A7 is a data processing system according to Example A1, wherein the operation of utilizing the public key certificate for the server application to establish the TLS communication channel comprises (a) at the server application, receiving a client-hello message from the client application and (b) automatically sending the public key certificate for the server application to the client application, in response to receiving the client-hello message. Example A7 may also include the features of any one or more of Examples A2 through A6.

Example B1 is at least one non-transitory machine-accessible medium comprising computer instructions for protecting extra-enclave communications. The computer instructions, in response to being executed on a data processing system, enable the data processing system to (a) allocate a portion of RAM in the data processing system to a server application that is to execute at a low privilege level; (b) create an enclave that comprises the portion of the RAM allocated to the server application, wherein the enclave protects the RAM in the enclave from access by software that executes at a high privilege level; (c) obtain, at the server application, a platform attestation report for the enclave from the processor, wherein the platform attestation report includes attestation data from the processor attesting to integrity of the enclave; (d) generate, at the server application, a public key certificate for the server application, wherein the public key certificate comprises the attestation data; and (e) utilize the public key certificate for the server application to establish a TLS communication channel between the server application in the enclave and a client application outside of the enclave.

Example B2 is at least one non-transitory machine-accessible medium according to Example B1, wherein the instructions, when executed, further enable the server application to (a) after obtaining the platform attestation report for the enclave from the processor, use the platform attestation report to obtain a signed attestation verification report (SAVR) from a third-party attestation server (TPAS); and (b) include the SAVR in the public key certificate. Also, the operation of utilizing the public key certificate for the server application to establish the TLS communication channel comprises utilizing the SAVR from the TPAS to establish the TLS communication channel.

Example B3 is at least one non-transitory machine-accessible medium according to Example B1, wherein the instructions, when executed, further enable the server application to generate, in the enclave, a private key and a corresponding public key for the server application. Also, the platform attestation report comprises a hash value derived from the public key of the server application, and the public key certificate comprises the hash value. Example B3 may also include the features of Example B2.

Example B4 is at least one non-transitory machine-accessible medium according to Example B1, wherein the operation of generating the public key certificate for the server application comprises formatting the public key certificate with an X.509 format, and including the attestation data in the public key certificate as an X.509 extension. Example B4 may also include the features of any one or more of Examples B2 through B3.

Example B5 is at least one non-transitory machine-accessible medium according to Example B1, wherein the instructions in the machine-accessible medium, when executed by the processor, implement the server application and a server launch module. Also, the operations of (a) allocating the portion of the RAM to the server application and (b) creating the enclave that comprises the portion of the RAM allocated to the server application are performed by the server launch module. Example B5 may also include the features of any one or more of Examples B2 through B4.

Example B6 is at least one non-transitory machine-accessible medium according to Example B1, wherein the machine-accessible medium further comprises a developer's enclave certificate for the enclave, wherein the developer's enclave certificate comprises a predetermined developer's measurement of the enclave and a digital signature of the developer, based on the predetermined developer's measurement of the enclave. Also, the instructions, when executed by the processor, enable the data processing system to use the developer's enclave certificate to evaluate trustworthiness of the server application before allowing the server application to execute in the enclave. Example B6 may also include the features of any one or more of Examples B2 through B5.

Example B7 is at least one non-transitory machine-accessible medium according to Example B1, wherein the operation of utilizing the public key certificate for the server application to establish the TLS communication channel comprises (a) at the server application, receiving a client-hello message from the client application, and (b) automatically sending the public key certificate for the server application to the client application, in response to receiving the client-hello message. Example B7 may also include the features of any one or more of Examples B2 through B6.

Example C1 is a method for protecting extra-enclave communications. The method comprises (a) in a data processing system with a processor in communication with RAM, allocating a portion of the RAM to a server application that is to execute at a low privilege level; (b) creating an enclave that comprises the portion of the RAM allocated to the server application, wherein the enclave protects the RAM in the enclave from access by software that executes at a high privilege level; (c) at the server application, obtaining a platform attestation report for the enclave from the processor, wherein the platform attestation report includes attestation data from the processor attesting to integrity of the enclave; (d) at the server application, generating a public key certificate for the server application, wherein the public key certificate comprises the attestation data; and (e) utilizing the public key certificate for the server application to establish a TLS communication channel between the server application in the enclave and a client application outside of the enclave.

Example C2 is a method according to Example C1, and further comprising (a) after obtaining the platform attestation report for the enclave from the processor, using the platform attestation report to obtain a signed attestation verification report (SAVR) from a third-party attestation server (TPAS); and (b) including the SAVR in the public key certificate. Also, the operation of utilizing the public key certificate for the server application to establish the TLS communication channel comprises utilizing the SAVR from the TPAS to establish the TLS communication channel.

Example C3 is a method according to Example C1, and further comprising generating, in the enclave, a private key and a corresponding public key for the server application. Also, the platform attestation report comprises a hash value derived from the public key of the server application, and the public key certificate comprises the hash value. Example C3 may also include the features of Example C2.

Example C4 is a method according to Example C1, wherein the operation of generating the public key certificate for the server application comprises formatting the public key certificate with an X.509 format, and including the attestation data in the public key certificate as an X.509 extension. Example C4 may also include the features of any one or more of Examples C2 through C3.

Example C5 is a method according to Example C 1, wherein the operations of (a) allocating the portion of the RAM to the server application and (b) creating the enclave that comprises the portion of the RAM allocated to the server application are performed by a server launch module. Also, the operation of utilizing the public key certificate for the server application to establish the TLS communication channel is performed by the server application. Example C5 may also include the features of any one or more of Examples C2 through C4.

Example C6 is a method according to Example C1, and further comprising using a developer's enclave certificate to evaluate trustworthiness of the server application before allowing the server application to execute in the enclave, wherein the developer's enclave certificate comprises a predetermined developer's measurement of the enclave and a digital signature of the developer, based on the predetermined developer's measurement of the enclave. Example C6 may also include the features of any one or more of Examples C2 through C5.

In view of the wide variety of useful permutations that may be readily derived from the example embodiments described herein, this detailed description is intended to be illustrative only, and should not be taken as limiting the scope of coverage.

What is claimed is:

1. A data processing system with technology for protecting extra-enclave communications, the data processing system comprising:
random access memory (RAM);
a processor in communication with the RAM, wherein the processor, when powered on, is capable of (a) allocating a portion of the RAM to a server application that is to execute at a low privilege level, (b) creating an enclave that comprises the portion of the RAM allocated to the server application, and (c) protecting the RAM in the enclave from access by software that executes at a high privilege level;
a machine-accessible medium responsive to the processor; and
instructions in the machine-accessible medium which, when executed by the processor, enable the server application to:
obtain a platform attestation report for the enclave from the processor, wherein the platform attestation report includes attestation data from the processor attesting to integrity of the enclave;
generate a public key certificate for the server application, wherein the public key certificate comprises the attestation data; and
utilize the public key certificate for the server application to establish a transport layer security (TLS) communication channel between the server application in the enclave and a client application outside of the enclave.

2. A data processing system according to claim 1, wherein the instructions, when executed, further enable the server application to:
after obtaining the platform attestation report for the enclave from the processor, use the platform attestation report to obtain a signed attestation verification report (SAVR) from a third-party attestation server (TPAS); and
include the SAVR in the public key certificate; and
wherein the operation of utilizing the public key certificate for the server application to establish the TLS communication channel comprises utilizing the SAVR from the TPAS to establish the TLS communication channel.

3. A data processing system according to claim 1, wherein the instructions, when executed, further enable the server application to:
generate, in the enclave, a private key and a corresponding public key for the server application; and wherein:
the platform attestation report comprises a hash value derived from the public key of the server application; and
the public key certificate comprises the hash value.

4. A data processing system according to claim 1, wherein the operation of generating the public key certificate for the server application comprises:
formatting the public key certificate with an X.509 format; and
including the attestation data in the public key certificate as an X.509 extension.

5. A data processing system according to claim 1, wherein:
the instructions in the machine-accessible medium, when executed by the processor, implement the server application and a server launch module; and
the operations of (a) allocating the portion of the RAM to the server application and (b) creating the enclave that comprises the portion of the RAM allocated to the server application are performed by the server launch module.

6. A data processing system according to claim 1, wherein:
the machine-accessible medium further comprises a developer's enclave certificate for the enclave, wherein the developer's enclave certificate comprises a predetermined developer's measurement of the enclave and a digital signature of the developer, based on the predetermined developer's measurement of the enclave; and
the processor, when powered on, is capable of using the developer's enclave certificate to evaluate trustworthiness of the server application before allowing the server application to execute in the enclave.

7. A data processing system according to claim 1, wherein the operation of utilizing the public key certificate for the server application to establish the TLS communication channel comprises:
at the server application, receiving a client-hello message from the client application; and
automatically sending the public key certificate for the server application to the client application, in response to receiving the client-hello message.

8. At least one non-transitory machine-accessible medium comprising computer instructions for protecting extra-enclave communications, wherein the computer instructions, in response to being executed on a data processing system, enable the data processing system to:
allocate a portion of random access memory (RAM) in the data processing system to a server application that is to execute at a low privilege level;
create an enclave that comprises the portion of the RAM allocated to the server application, wherein the enclave protects the RAM in the enclave from access by software that executes at a high privilege level;
obtain, at the server application, a platform attestation report for the enclave from the processor, wherein the platform attestation report includes attestation data from the processor attesting to integrity of the enclave;
generate, at the server application, a public key certificate for the server application, wherein the public key certificate comprises the attestation data; and
utilize the public key certificate for the server application to establish a transport layer security (TLS) communication channel between the server application in the enclave and a client application outside of the enclave.

9. At least one non-transitory machine-accessible medium according to claim 8, wherein the instructions, when executed, further enable the server application to:
after obtaining the platform attestation report for the enclave from the processor, use the platform attestation report to obtain a signed attestation verification report (SAVR) from a third-party attestation server (TPAS); and
include the SAVR in the public key certificate; and
wherein the operation of utilizing the public key certificate for the server application to establish the TLS communication channel comprises utilizing the SAVR from the TPAS to establish the TLS communication channel.

10. At least one non-transitory machine-accessible medium according to claim 8, wherein the instructions, when executed, further enable the server application to:
generate, in the enclave, a private key and a corresponding public key for the server application; and wherein:
the platform attestation report comprises a hash value derived from the public key of the server application; and
the public key certificate comprises the hash value.

11. At least one non-transitory machine-accessible medium according to claim 8, wherein the operation of generating the public key certificate for the server application comprises:
formatting the public key certificate with an X.509 format; and
including the attestation data in the public key certificate as an X.509 extension.

12. At least one non-transitory machine-accessible medium according to claim 8, wherein:
the instructions in the machine-accessible medium, when executed by the processor, implement the server application and a server launch module; and
the operations of (a) allocating the portion of the RAM to the server application and (b) creating the enclave that comprises the portion of the RAM allocated to the server application are performed by the server launch module.

13. At least one non-transitory machine-accessible medium according to claim 8, wherein:
the machine-accessible medium further comprises a developer's enclave certificate for the enclave, wherein the developer's enclave certificate comprises a predetermined developer's measurement of the enclave and a digital signature of the developer, based on the predetermined developer's measurement of the enclave; and
the instructions, when executed by the processor, enable the data processing system to use the developer's enclave certificate to evaluate trustworthiness of the server application before allowing the server application to execute in the enclave.

14. At least one non-transitory machine-accessible medium according to claim 8, wherein the operation of utilizing the public key certificate for the server application to establish the TLS communication channel comprises:
at the server application, receiving a client-hello message from the client application; and
automatically sending the public key certificate for the server application to the client application, in response to receiving the client-hello message.

15. A method for protecting extra-enclave communications, the method comprising:
in a data processing system with a processor in communication with random access memory (RAM), allocating a portion of the RAM to a server application that is to execute at a low privilege level;
creating an enclave that comprises the portion of the RAM allocated to the server application, wherein the enclave protects the RAM in the enclave from access by software that executes at a high privilege level;
at the server application, obtaining a platform attestation report for the enclave from the processor, wherein the platform attestation report includes attestation data from the processor attesting to integrity of the enclave;
at the server application, generating a public key certificate for the server application, wherein the public key certificate comprises the attestation data; and
utilizing the public key certificate for the server application to establish a transport layer security (TLS) communication channel between the server application in the enclave and a client application outside of the enclave.

16. A method according to claim 15, further comprising:
after obtaining the platform attestation report for the enclave from the processor, using the platform attestation report to obtain a signed attestation verification report (SAVR) from a third-party attestation server (TPAS); and
including the SAVR in the public key certificate; and
wherein the operation of utilizing the public key certificate for the server application to establish the TLS communication channel comprises utilizing the SAVR from the TPAS to establish the TLS communication channel.

17. A method according to claim 15, further comprising:
generating, in the enclave, a private key and a corresponding public key for the server application; and wherein:
the platform attestation report comprises a hash value derived from the public key of the server application; and
the public key certificate comprises the hash value.

18. A method according to claim 15, wherein the operation of generating the public key certificate for the server application comprises:
formatting the public key certificate with an X.509 format; and
including the attestation data in the public key certificate as an X.509 extension.

19. A method according to claim 15, wherein:
the operations of (a) allocating the portion of the RAM to the server application and (b) creating the enclave that comprises the portion of the RAM allocated to the server application are performed by a server launch module; and
the operation of utilizing the public key certificate for the server application to establish the TLS communication channel is performed by the server application.

20. A method according to claim 15, further comprising:
using a developer's enclave certificate to evaluate trustworthiness of the server application before allowing the server application to execute in the enclave, wherein the developer's enclave certificate comprises a predetermined developer's measurement of the enclave and a digital signature of the developer, based on the predetermined developer's measurement of the enclave.
